(19) United States
(12) Patent Application Publication
(10) Pub. No.: US 2023/0401034 A1
(43) Pub. Date: Dec. 14, 2023

(54) Methods, Systems, and Circuits for Coordinated Optimization in In-Memory Sorting

(71) Applicant: University of Virginia Patent Foundation, Charlottesville, VA (US)

(72) Inventors: Marzieh Lenjani, Cupertino, CA (US); Alif Ahmed, Charlottesville, VA (US); Kevin Skadron, Charlottesville, VA (US)

(21) Appl. No.: 18/330,666

(22) Filed: Jun. 7, 2023

Related U.S. Application Data
(60) Provisional application No. 63/366,125, filed on Jun. 9, 2022.

(51) Int. Cl. G06F 7/26; G06F 7/49

(52) U.S. Cl. CPC G06F 7/26; G06F 7/49

(57) ABSTRACT

Disclosed herein are systems, methods, and computer-readable media for sorting datasets within a Processing in Memory (PIM)-based system. A request to sort a dataset stored in a 3D-stacked memory can be received. The request can identify a specific dataset and sorting criteria, which includes a plurality of keys. The dataset can be partitioned into several subarrays across various memory banks within the 3D-stacked memory. Each piece of data within these subarrays can be separated into buckets based on the keys. Local histograms for each subarray and bank histograms based on the local histograms can be generated. A prefix-sum operation on the bank histograms can determine individual positions for the sorted dataset. Aggregation of the subarrays from all memory banks can form the sorted dataset, which can be subsequently returned.

### RELATED APPLICATIONS

This application also claims priority to U.S. Provisional Patent Application No. 63/366,125, filed on Jun. 9, 2022, entitled “Methods, Systems, And Circuits for Co-Optimization for In-Memory Sorting,” which is hereby incorporated by reference in its entirety. Any and all applications for which a domestic priority claim is identified in the Application Data Sheet of the present application are hereby incorporated by reference under 37 CFR 1.57.

### STATEMENT OF GOVERNMENT SUPPORT

This invention was made with government support under Grant No. HR0011-18-3-0004 awarded by the Department of Defense/Defense Advanced Research Projects Agency (DARPA). The government has certain rights in the invention.

### FIELD

Various embodiments of the disclosure relate to improving the performance of sorting algorithms through hardware and algorithm co-optimization. More specifically, various embodiments of the disclosure relate to reducing the data movement overhead and random accesses associated with radix sorting algorithms in processing in memory (PIM) architectures.

### BACKGROUND

Sorting is an operation in many computer systems and applications that is used to organize and process large amounts of data efficiently. Sorting algorithms often require many passes on the data, with each pass involving significant data movement overhead. This overhead can be minimized by using Processing in Memory (PIM) architectures, which can reduce data movement and provide high parallelism. The radix sorting algorithm is a scalable algorithm that can exploit PIM's parallelism. However, radix sorting is inefficient for current PIM-based accelerators for several reasons.

### SUMMARY

Some embodiments of the present disclosure describe a method for sorting a dataset in a processing in memory (PIM)-based system. The method can include receiving a request to sort a dataset stored in a 3D-stacked memory of the PIM-based system, where the request identifies a specific dataset and sorting criteria. The sorting criteria include a plurality of keys used to sort pieces of data in the dataset. The method can include partitioning the dataset into a plurality of subarrays across a plurality of memory banks within the 3D-stacked memory, where each subarray contains at least one piece of data. The pieces of data in each subarray can be separated into a plurality of buckets based on the plurality of keys. Each bucket corresponds to a particular key, and the same plurality of buckets is used for each subarray. Local histograms can be generated for each subarray, indicating the frequency of a particular key in the corresponding bucket. Bank histograms can be generated by combining key counts from all local histograms corresponding to the same bucket. A prefix-sum operation is performed on the bank histograms to determine individual positions of the pieces of data for a sorted dataset. The subarrays from all memory banks can be aggregated based on the individual positions to form the sorted dataset, which is then returned.

Some embodiments of the present disclosure describe a computer-readable medium storing instructions that, when executed by a processing in memory (PIM) based system, cause the system to perform a method for sorting a dataset. The method can include receiving a request to sort a dataset stored in a 3D-stacked memory of the PIM-based system, where the request identifies a specific dataset and sorting criteria. The sorting criteria include a plurality of keys used to sort pieces of data in the dataset. The method can include partitioning the dataset into a plurality of subarrays across a plurality of memory banks within the 3D-stacked memory, where each subarray contains at least one piece of data. The pieces of data in each subarray can be separated into a plurality of buckets based on the plurality of keys. Each bucket corresponds to a particular key, and the same plurality of buckets is used for each subarray. Local histograms can be generated for each subarray, indicating the frequency of a particular key in the corresponding bucket. Bank histograms can be generated by combining key counts from all local histograms corresponding to the same bucket. A prefix-sum operation is performed on the bank histograms to determine individual positions of the pieces of data for a sorted dataset. The subarrays from all memory banks can be aggregated based on the individual positions to form the sorted dataset, which is then returned.

Some embodiments of the present disclosure describe a system for sorting a dataset in a processing in memory (PIM)-based system. The system can include a 3D-stacked memory that can be configured to store a dataset, comprising a plurality of memory banks that can be partitioned into a plurality of subarrays across the memory banks. Each subarray can include at least one piece of data from the dataset. The system can include a processing unit that can be configured to receive a request to sort the dataset, where the request can identify a specific dataset and sorting criteria. The sorting criteria can include a plurality of keys used to sort pieces of data in the dataset. The system can also include a plurality of subarray-level processing units (SPUs) that can be operatively coupled to the subarrays. The SPUs can be configured to separate each piece of data in each subarray into a plurality of buckets based on the plurality of keys. Each bucket can correspond to a particular key of the plurality of keys. The SPUs can generate a plurality of local histograms for each subarray, where each local histogram of a particular subarray corresponds to a particular bucket of the plurality of buckets and indicates a frequency of a particular key in the corresponding bucket. The system can further include a bank histogram generator that can be configured to generate a plurality of bank histograms based on the plurality of local histograms. Each bank histogram can correspond to a particular bucket of the plurality of buckets, where the generating can include combining key counts from all local histograms corresponding to the same bucket of the plurality of buckets. The system can include a prefix-sum operation module that can be configured to perform a prefix-sum operation on the plurality of bank histograms to determine individual positions of the pieces of data for a sorted dataset. Additionally, the system can include an aggregator that can be configured to aggregate the subarrays from all memory banks to form the sorted dataset based on the individual positions and to return the sorted dataset.

### BRIEF DESCRIPTION OF THE DRAWINGS

The present disclosure is illustrated by way of example, and not limitation, in the figures of the accompanying drawings, in which like reference numerals indicate similar elements and in which:

FIGS. 1A-1D illustrates the structure of the intermediate array and the pseudo-code of three steps of the radix sorting mapped to a PIM-based accelerator that has one processing unit per subarray (SPU) and one aggregator core, located far from the subarrays.

FIGS. 2A-2D illustrate an embodiment of an architecture for utilizing 3D-stacked memories to achieve high performance, in accordance with the present inventive concept.

FIG. 3 is a graph illustrating throughput comparisons of the present inventive concept against Bonsai and IMC.

FIG. 4 is a flow diagram illustrative of an embodiment of a routine for sorting a dataset in a PIM-based system.

### DETAILED DESCRIPTION

The present inventive concepts relate to methods, systems, computer-readable media, and circuits for sorting data using processing in memory (PIM) technology. Sorting is a kernel operation that uses multiple passes on data, and each pass imposes significant data movement overhead. Conventional systems that use PIM technology for sorting data can have limitations such as a large intermediate array per processing unit, requiring a prefix-sum operation across all the large intermediate arrays, and significant random accesses, which can be costly in PIM. These limitations can result in reduced sorting performance and increased power consumption.

The present inventive concepts can address at least these limitations by enabling every group of processing elements to cooperatively share and generate an intermediate array, reducing the capacity overhead of intermediate arrays and performance overhead of the prefix-sum operation. The present inventive concepts can also eliminate random accesses by adding a local sorting step to the radix sorting and providing efficient hardware support for this step. Furthermore, the present inventive concepts can use 3D-stacked memories, such as HMC/HBM, which connect banks through an interconnection network with a dragonfly topology and subarrays through a line interconnection topology. In some cases, the memory stack can have one logic layer, and the system can use a subarray-level PIM approach called Fulcrum/Gearbox as the baseline PIM architecture. Example description and examples of the Gearbox can be found in U.S. application Ser. No. 18/306,531 (hereinafter “the '531 application”), filed Apr. 25, 2023, entitled “Memory Devices Including Processing-In-Memory Architecture Configured to Provide Accumulation Dispatching and Hybrid Partitioning,” which is hereby incorporated by reference.

The advantages of the present inventive concepts can include improved sorting performance, reduced power consumption, and efficient use of PIM technology. The present inventive concepts can deliver increased (e.g., 5×, 10×, 20×, 40×) speedup compared to a state-of-the-art near-HBM FPGA-based sorting accelerator and increased (e.g., 3×, 5×, 10×, 13×, 15×, 20×) speedup compared to an in-logic-layer-based sorting accelerator. The present inventive concepts can be used in other important kernels such as graph processing and database operations.

### INTRODUCTION

Sorting is widely used and appears in many big data applications and database operations, such as index creation, sort-merge joins, and user-requested output sorting. Accordingly, some studies have focused on accelerating sorting using FPGA and ASIC. Some factors can limit the performance of these accelerators. For example, these accelerators can employ merge-based sorting algorithms, where all the data should eventually pass through a single merging point, which can result in a bottleneck. As another example, these approaches can impose significant data movement overhead because they can move data between memory and processing units in several passes (for datasets too large for the accelerators' SRAM buffers), where each pass can perform only a few operations per loaded datum from memory. Since data movement in current systems can be orders of magnitude costlier than arithmetic and logic operations, the data movement overhead can dominate the total execution time and energy consumption. PIM architectures can alleviate this data movement overhead by processing data inside the memory.

PIM-based accelerators may provide high parallelism by placing one or several ALUs per memory segment, such as one ALU per memory subarray or a few ALUs per bank, inside memory layers. These PIM-based accelerators are often referred to as in-memory-layer accelerators. New high-bandwidth interconnects, such as NVLink, can provide all-to-all connections between multiple devices and increase the connectivity of multi-device PIMs, providing even higher capacity and parallelism. Therefore, it may be important to employ scalable algorithms, such as radix sorting, which have the potential to take advantage of the high parallelism and high connectivity of multi-device in-memory-layer PIM-based accelerators. The radix sorting algorithm is a scalable algorithm that can exploit PIM's parallelism. However, radix sorting is inefficient for current PIM-based accelerators for several reasons. First, it requires a large intermediate array per processing unit, which wastes capacity. Second, it requires a prefix-sum operation across all the large intermediate arrays, imposing performance overhead. Finally, radix sorting requires significant random accesses, which are costly in PIM.

Radix sorting splits the k bits of keys into smaller d-bit digits, and sorts data in dk/de passes. In each pass, the algorithm partitions the keys into radix=2d distinct buckets and places a key in a bucket in three steps. The first step is Local histogram, where each processing unit generates a histogram array by counting the number of keys in each bucket. In the second step, the algorithm performs Prefix-sum operations across all local histogram arrays generated by all processing elements. Finally, in the third step, Key placement, each processing unit uses the prefix-sum results to find the address of each key in the pass's sorted output and writes the key in the correct address. This last step moves keys among memory segments, memory stacks, and devices, introducing significant data movement overhead. Therefore, to reduce data movement overhead for sorting, we need to reduce the number of passes by employing large radixes.

However, implementing large-radix sorting in PIM is challenging for three reasons. First, large-radix sorting requires reserving a large histogram array per processing element, wasting the capacity. Second, the Local histogram step introduces random accesses to the histogram array. Random access to a large array is very costly in PIM because memory reads the data at a row granularity, only a few Kbits. If the histogram array does not fit in one row, each random access to the histogram array may need to load a new row, imposing significant performance and energy overhead. Third, the Prefix-sum step with large radix imposes significant performance overhead because, in current in-memory-layer accelerators, the prefix-sum operation across memory segments should be performed using a core far from memory segments. The core moves all the histogram values and prefix-sum values between the memory segments and the core.

Embodiments of the present disclosure address challenges in implementing large-radix sorting in PIM. A PIM architecture can be employed, such as the baseline architecture referred to as Fulcrum, which can include one lightweight processing unit per two subarrays. Fulcrum employs a version of radix sorting that does not calculate the length of each bucket, and instead assumes that all buckets have almost the same length, and that a bucket in each pass can always fit in one subarray. However, these assumptions may not be accurate for sorting large amounts of real-world data, where data is unevenly distributed among buckets and exceeds the capacity of one subarray.

Embodiments of the present disclosure address these inefficiencies of Fulcrum by enabling radix sorting that calculates the length of each bucket and/or the position of each key within each bucket, such as by using histogram and/or prefix-sum values. The present disclosure can enable large radix sorting, which can advantageously reduce the number of passes required to sort data, thereby decreasing data movement overhead.

Embodiments described herein provide an algorithm/hardware co-optimization by which every group of processing units can cooperatively generate a shared intermediate array. In the present disclosure, each processing unit can locally sort its keys and optimize the local sorting by exploiting an efficient sequential mechanism for dichotomizing keys. Disclosed herein is hardware that can enable filling and processing the two buckets in binary radix sorting from two different directions, reducing or eliminating the histogram generation step for the local binary radix sorting.

In some cases, each processing unit can iteratively generate a small part of the histogram array (e.g., 256 elements) and can reduce this small part in the large shared intermediate array. In certain embodiments, the local sorting step may facilitate part-by-part histogram generation, which can offer a range of advantages. Such benefits may include, but are not limited to, reducing the size of the intermediate array per processing unit, reducing or eliminating random accesses to the shared intermediate array, and improving the overall efficiency of the sorting process.

Embodiments described herein can advantageously reduce the overhead of prefix-sum operations on histogram arrays by requiring, in some cases, only one histogram array per group of processing elements. This approach can improve sorting efficiency and reduce the size of the intermediate array per processing unit, providing a more streamlined and effective sorting process. Some embodiments described herein may require more than one histogram array per group of processing elements in certain cases, but even in such cases, they can still reduce the overhead of prefix-sum operations on histogram arrays compared to conventional sorting techniques.

Embodiments described herein can include an approach for gigabyte sorting using an in-memory-layer approach. In some cases, the number of required passes for sorting is reduced by enabling large-radix sorting. PIM devices with high parallelism and all-to-all connectivity of recent interconnections can be exploited in these embodiments. The effect of these embodiments is evaluated against a near-HBM FPGA-based approach and an in-logic-layer-based sorting accelerator.

Implementing large-radix sorting in PIM can be challenging due to the large histogram array required per processing element, which can waste capacity, and the random accesses and Prefix-sum step performance overhead associated with large radixes. However, embodiments of the present disclosure can address these challenges by enabling large-radix sorting that calculates the length of each bucket and/or the position of each key within each bucket, such as by using histogram and/or prefix-sum values. The present disclosure can enable large radix sorting, which can advantageously reduce the number of passes required to sort data, thereby decreasing data movement overhead.

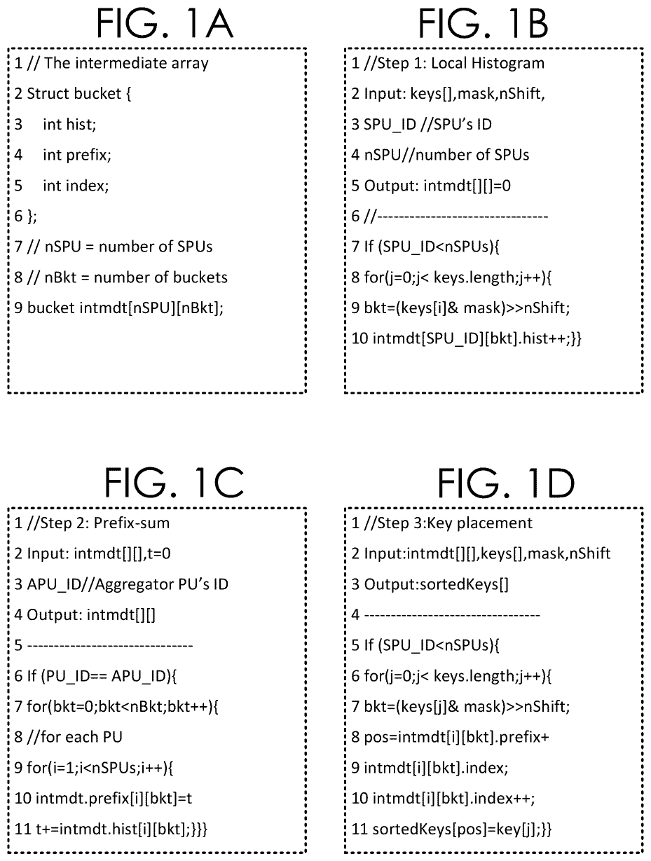

FIGS. 1A-1D illustrates the structure of the intermediate array and the pseudo-code of three steps of the radix sorting mapped to a PIM-based accelerator that has one processing unit per subarray (SPU) and one aggregator core, located far from the subarrays. FIG. 1A shows that each element of the intermediate array has three fields: (i) histogram value (hist), prefix-sum value (prefix), and index. The index field is used in the Key placement step and keeps the current index of the bucket. To save memory space, the prefix-sum can be performed in place, reducing the number of fields to two fields. As an example, if radix=216, each SPU requires at least 512 KB (216×2×4) memory space for the intermediate array.

In addition to the capacity overheads, operations on intermediate arrays impose performance overhead due to (i) random accesses and (ii) the prefix-sum operation. Line 10 in FIG. 1B and lines 8-10 in FIG. 1D show the random access to the intermediate array. FIG. 1C shows the prefix-sum operation on intermediate arrays, where an APU moves many histogram values and prefix-sum values between subarrays and the APU. Hence, the overhead of the prefix-sum operations is on the order of n*r, where n is the number of subarray-level processing units, and r is the number of buckets. Some embodiments disclosed herein reduce these capacity and performance overheads.

PIM Architecture

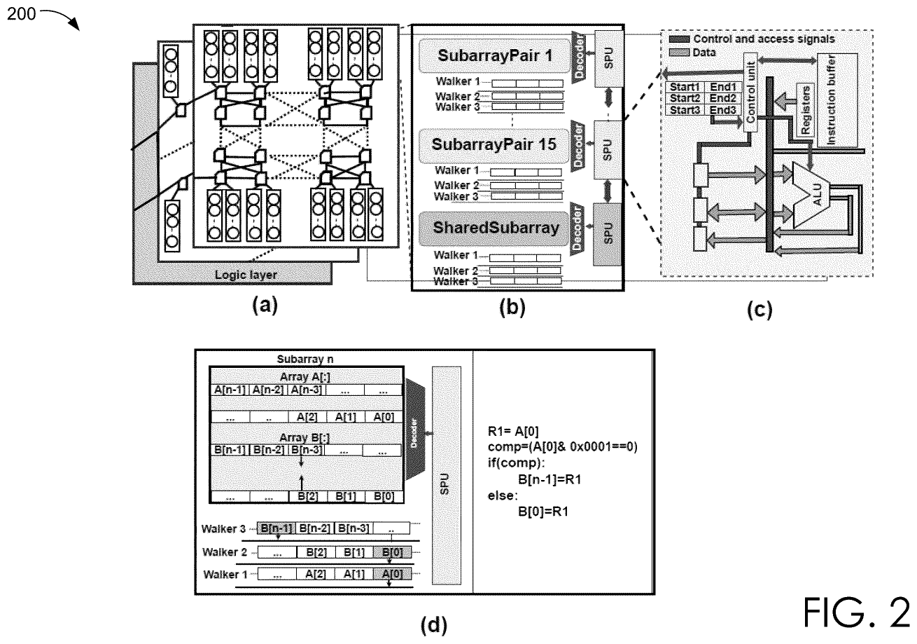

FIGS. 2A-2D illustrate an embodiment of an architecture (sometimes referred to as system 200) for utilizing 3D-stacked memories to achieve high performance, in accordance with the present inventive concept. FIG. 2A depicts an embodiment of the architecture for subarray-level processing in-memory (PIM) approach in the disclosed inventive concept. The architecture includes circles representing subarrays, rectangles representing banks, and pentagons representing switches. Banks are connected using a dragonfly topology. FIG. 2B illustrates a bank with a subarray-level processing unit (SPU) and three Walkers per subarray pair. FIG. 2C provides an architectural view of each SPU. FIG. 2D presents an example of local binary radix sorting. In this example, an SPU loads one row of array A[:] into Walker1. In each cycle, the SPU reads one entry from Walker1 and places it into either Walker2 or Walker3 based on the binary digit being processed. Once Walker1 is fully read, the SPU loads a new row from array A[:] into Walker1. Once either Walker2 or Walker3 is full, the SPU writes the row into array B[:]. However, the SPU writes Walker1 in rows starting from the start of array B[:] and writes Walker3 in rows starting from the end of the array B[:].

In the 3D-stacked memory, such as HMC/HBM, each memory stack can include multiple layers. Within each layer, banks can be connected through an interconnection network with a dragonfly topology. Within each bank, subarrays can be connected through a line interconnection topology. Two banks within a layer form a group, which are connected across horizontally aligned layers by through-silicon vias (TSVs) to form a vault. The architecture also includes a logic layer. It should be noted that the disclosed inventive concepts can be adapted for use with DIMM.

In some cases, a subarray-level PIM approach, Fulcrum/Gearbox, is utilized as the baseline PIM architecture. In Fulcrum, every subarray pair has one simplified sequential processing unit (see FIG. 2B), and each vault has a core in the logic layer. Each subarray-level processing unit (SPU) has a few registers, an 8-entry instruction buffer, a controller, and an ALU (see FIG. 2C). (The design may be motivated by the characteristics of memory-intensive applications, where there are few simple operations per loaded datum in each step of the process.) The core in the logic layer can include several roles, including but not limited to, broadcasting the eight instructions to all SPUs at the beginning of each step or performing aggregation operations.

In Fulcrum, every pair of subarrays can have three row-wide buffers, referred to as “Walkers.” The Walkers load an entire row from the subarray at once, but the processing units sequentially access and process one word at a time. Sequential access is enabled by using a one-hot-encoded value, where the set bit in this value selects the accessed word. Therefore, to sequentially process the row, the processing unit only needs to shift the one-hot encoded value, making sequential processing highly efficient. In some cases, Fulcrum is selected as the baseline architecture because the three Walkers provide three parallel efficient sequential assess, enabling an efficient mechanism for dichotomizing keys into two groups, which is the main operation in binary radix sorting.

Fulcrum also cannot efficiently move data among memory banks and assumes that data is already bucketed among banks, during the data transfer between the host and the accelerator. This assumption may not be true in many scenarios. The second version of Fulcrum, Gearbox adds interconnection and hardware support for moving data between banks and subarrays. In some embodiments, this capability is employed in Key placement step to send keys to their destination subarray.

In some embodiments of the inventive concept, the radix of 216 is employed to reduce or minimize the number of passes required for bucketization. For 32-bit/64-bit keys, two/four passes of bucketization on data may be required, each comprising four steps: (i) Local sorting, (ii) Local histogram, (iii) Prefix sum, and (iv) Key placement.

The three Walkers with shift-based sequential access mechanisms can be highly efficient for binary radix sorting, where there may be a need to dichotomize an array of keys into two buckets (Bucket0 and Bucket1). To achieve this objective, the key array can be loaded row-by-row in Walker1, and Walker2 and Walker3 can be utilized as Bucket0 and Bucket1, respectively. Then, as shown in FIG. 2 (d), in each clock cycle, the SPU shifts the one-hot-encoded value to read one key from Walker1 and writes it to either Walker2 or Walker3 based on the digit being processed by shifting the one-hot-encoded value of the corresponding Walker.

Binary radix sorting can be efficient because it requires no random access. However, a problem is that, with non-uniformly distributed keys, the size of each binary bucket can be very different in each pass. To address at least this issue, instead of reserving a large space for each binary bucket, the disclosed inventive concepts reserve a space that is almost the size of the key array. A hardware controller starts Bucket0 from the bottom of the space and fills it upward and starts Bucket1 from the end of the space and fills it downward (FIG. 2 (d)). The reverse ordering of keys in Bucket1 can violate stability, a requirement for radix sorting. To maintain stability, the end address of Bucket0 is stored as metadata to distinguish the two buckets. In the next pass, the controller processes Bucket1 from end to start.

In some cases, for the local histogram step, 15 processing units in a bank can cooperatively generate one large intermediate array in the lower subarray in the bank. The step can include three substeps. First, each SPU generates the histogram values of the first 256 buckets. Second, all SPUs reduce the histogram values of each of the 256 buckets in the lower subarray. Third, all SPUs go to the first sub step, to generate the histogram values of the next 256 buckets, until the histogram values of all the 216 buckets are generated.

As described herein, the second substep can include reducing the histogram values of 256 buckets. Cooperative operations can perform this operation, where X processing elements can work together to reduce their histogram values in the last subarray of the bank (where X can be 5, 10, 15, 20, etc.). Assuming the histogram array in the i^{th} subarray pair is Hist[i][:], the Cooperative reduction is as follows: the i^{th} SPU receives a value from (i−1)^{th} SPU, adds this value to the histogram value of the j^{th} bucket (Hist[i][j]), and passes the result to the (i+1)^{th} SPU.

In the disclosed 3D-stacked memory, 256 subarrays share a bus (TSVs). A naive PIM-based approach performs prefix-sum operations on all histogram values in 256 subarrays, imposing significant overhead for reading and writing these values through the shared bus. By reducing the number of intermediate arrays, the overhead of prefix-sum can be decreased to that of prefix-sum on only 16 histogram arrays in a vault. (The cores in the vaults also aggregate their prefix-sum arrays.)

The process of finding the exact position of each key is very similar to the original radix sorting, as shown in Line 11 of FIG. 1 (d). In this step, keys in the 15 subarrays are sent to the lower subarray, where the shared histogram array resides. Then, the SPU at the bank level derives the position of the key in the sorted output array and sends the key and its address through the interconnection toward the destination subarray. Gearbox adds hardware support for transferring data elements from one subarray to another. This capability is employed for sending each key to its destination subarray.

The inventive concepts described herein (sometimes referred to as “Pulley”) can target sorting gigabytes of data, requiring a capacity beyond what one memory stack can provide. New interconnection technologies, such as NVLink, can enable high-bandwidth fully connected topology among multiple devices, increasing the capacity of an accelerator. To evaluate Pulley, six devices were connected, each having four stacks of 8-GB memories, providing 192 GB capacity. Four stacks per device were selected to ensure each device's power consumption is less than 300 Watt. The 6-device setting was chosen because the second generation of NVLink allows six links per device. (The third and fourth generations allow 12 and 18 links per device.) For each stack, configurations from Fulcrum were followed. An in-house event-accurate simulator was developed for Pulley, and the source code of the simulator was released.

The disclosed inventive concepts were compared against a state-of-the-art near-HBM FPGA-based sorting accelerator and an in-logic-layer sorting accelerator. The disclosed inventive concepts, on average, deliver a 20× speedup compared to Bonsai and a 13× speedup compared to IMC.

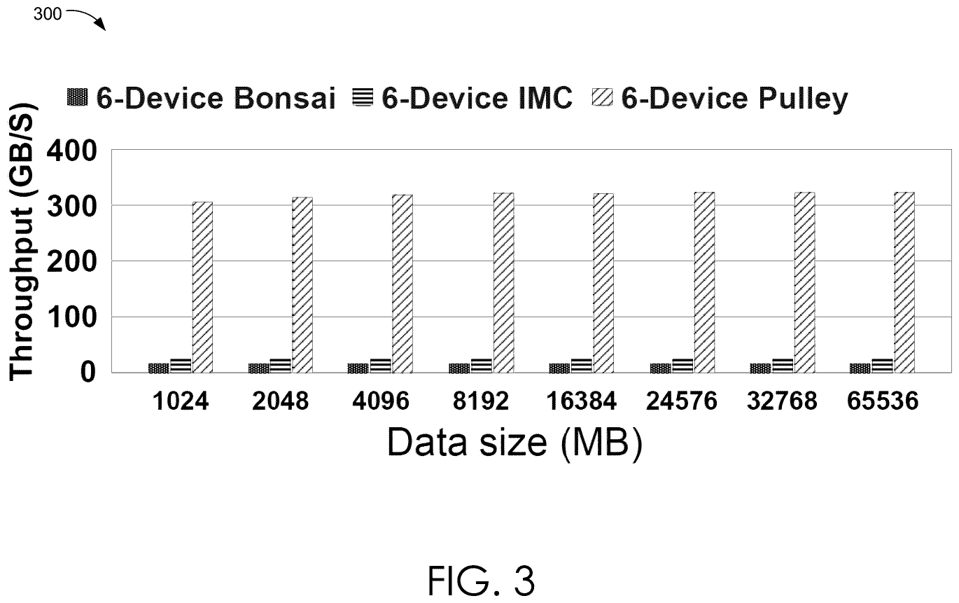

FIG. 3 is a graph 300 illustrating throughput comparisons of the present inventive concept (e.g., Pulley) against Bonsai and IMC. For the evaluation of energy consumption, the memory elements and interconnected elements in Pulley were analyzed using CACTI3DD. The power consumption of processing units was evaluated through RTL synthesis. The average power consumption of Pulley per stack is 38.6 watts. The average power density is 540 mW/mm², which is under the power density budget of a PIM-based accelerator with a high-end server active cooling (1214 mW/mm²) and under the power budget of the PCIe peripheral interface (300 Watts per device and 75 per stack).

The inventive concepts described herein provide hardware support for sharing intermediate arrays in sorting, as well as optimized operations on the shared intermediate by providing hardware support for Cooperative operations. By reducing the overhead of prefix-sum and enabling efficient key transfer between subarrays, this approach offers significant performance gains over existing sorting accelerators. Furthermore, the inventive concepts described herein improve other important kernels such as graph processing and database operations.

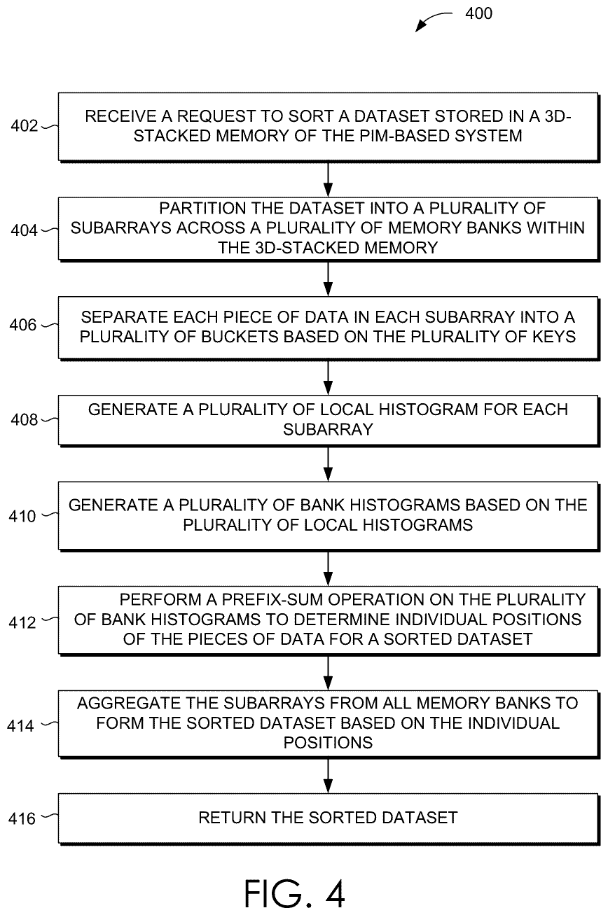

FIG. 4 is a flow diagram illustrative of an embodiment of a routine 400 for sorting a dataset in a PIM-based system. It will be understood that one or more elements outlined for routine 400 can be implemented using any combination of software or hardware. Furthermore, fewer, more, or different blocks can be used as part of the routine 400.

At block 402, the system receives a request to sort a specific dataset. This dataset is stored in the 3D-stacked memory of the PIM-based system. The request identifies the dataset and sorting criteria, where the sorting criteria include a plurality of keys. The keys are utilized to sort the individual pieces of data in the dataset. The use of multiple keys enables a versatile sorting process, allowing the system to accommodate various sorting criteria based on the needs of the data or the requirements of the subsequent data operations.

At block 404, the system 200 partitions the dataset into a plurality of subarrays across numerous memory banks within the 3D-stacked memory. Each subarray can include at least one piece of data from the dataset. By partitioning the data in this manner, the system 200 can ensure a balanced distribution of data across the memory banks, promoting efficient utilization of memory resources and enhancing the overall sorting speed due to concurrent processing across multiple memory banks. In some cases, the partitioning process is performed in such a way that it substantially evenly distributes the data across the memory banks. Alternatively, in some cases, the partitioning process is performed in such a way that it unevenly distributes the data across the memory banks.

At block 406, the system 200 separates each piece of data in each subarray into a plurality of buckets. These buckets can be based on the plurality of keys. Each bucket can correspond to a particular key from the plurality of keys. The same set of buckets can be used for each subarray, providing a consistent sorting framework across all subarrays. This key-based bucketing approach can enable efficient grouping of data, providing a granular sorting mechanism that offers increased flexibility in handling diverse datasets. The separation can be accomplished by performing local binary radix sorting within each subarray and can be employed to sort the pieces of data according to their corresponding keys. The separating can be based on a radix sort technique.

The local binary radix sorting within each subarray can be performed concurrently across all subarrays, though it may also be executed in a serial manner, depending on the system's configurations and the nature of the dataset. While concurrent execution can significantly enhance the speed and efficiency of the sorting process through parallel processing, serial execution may be appropriate for certain types of data or system configurations. Whether performed concurrently or serially, the sorting operation can sort the pieces of data based on their corresponding keys, effectively organizing the dataset. The flexibility in execution style allows for adaptability in various use cases and requirements, catering to a wide range of sorting needs.

At block 408, the system 200 generates a local histogram for each subarray. Each local histogram can correspond to a particular bucket from the plurality of buckets. Each local histogram can indicate the frequency of a particular key in the corresponding bucket. Through the generation of these local histograms, the system 200 can provide a clear representation of the distribution of keys within each subarray, facilitating an efficient sorting process by leveraging frequency-based sorting techniques.

At block 410, the system 200 generates a plurality of bank histograms based on the local histograms. Each bank histogram can correspond to a particular bucket from the plurality of buckets. The generation process can include combining key counts from all local histograms corresponding to the same bucket. By aggregating the data in this manner, the system 200 can create a comprehensive view of the key distribution across the memory banks, which can be important for the sorting process.

At block 412, the system 200 performs a prefix-sum operation on the bank histograms to determine the individual positions of the pieces of data for a sorted dataset. This operation can include using the key distribution information from the bank histograms to assign positions to each data piece in the final sorted dataset. The prefix-sum operation can ensure that the sorted dataset maintains the correct order as specified by the sorting criteria.

At block 414, the system 200 aggregates the subarrays from all memory banks to form the sorted dataset based on the individual positions. This aggregation process can consolidate the sorted subarrays into a single dataset while preserving the order determined by the prefix-sum operation. This step can be the culmination of the sorting process, where the individual sorted subarrays are brought together to form the complete sorted dataset.

At block 416, the system 200 returns the sorted dataset. The dataset, sorted according to the specified criteria, is then ready for further processing or retrieval as required. By delivering a sorted dataset, the system 200 can ensure organized and efficient access to data, facilitating subsequent data operations and analyses.

What is claimed is:

1. A method for sorting a dataset in a processing in memory (PIM)-based system, the method comprising:
receiving a request to sort a dataset stored in a 3D-stacked memory of the PIM-based system, wherein the request identifies a specific dataset and sorting criteria, wherein the sorting criteria includes a plurality of keys used to sort pieces of data in the dataset;
partitioning the dataset into a plurality of subarrays across a plurality of memory banks within the 3D-stacked memory, wherein each subarray includes at least one piece of data from the dataset;
separating each piece of data in each subarray into a plurality of buckets based on the plurality of keys, wherein each bucket corresponds to a particular key of the plurality of keys, wherein a same plurality of buckets is used for each subarray;
generating a plurality of local histogram for each subarray, wherein each local histogram of a particular subarray corresponds to a particular bucket of the plurality of buckets, and wherein each local histogram indicates a frequency of a particular key in the corresponding bucket;
generating a plurality of bank histograms based on the plurality of local histograms, wherein each bank histogram corresponds to a particular bucket of the plurality of buckets, wherein the generating comprises combining key counts from all local histograms corresponding to a same bucket of the plurality of buckets;
performing a prefix-sum operation on the plurality of bank histograms to determine individual positions of the pieces of data for a sorted dataset;
aggregating the subarrays from all memory banks to form the sorted dataset based on the individual positions; and
returning the sorted dataset.

2. The method of claim 1, wherein said partitioning the dataset comprises partitioning the dataset in a manner that substantially evenly distributes the data across the memory banks.

3. The method of claim 1, wherein separating each piece of data in each subarray into a plurality of buckets based on the plurality of keys comprises performing local binary radix sorting within each subarray to sort the pieces of data according to their corresponding keys.

4. The method of claim 3, wherein the local binary radix sorting within each subarray is performed concurrently across all subarrays, thereby concurrently sorting the pieces of data based on their corresponding keys.

5. The method of claim 1, wherein said separating is based on a radix sort technique.

6. The method of claim 1, wherein said generating the plurality of local histograms for each subarray is performed using subarray-level processing units (SPUs) that cooperate to create intermediate arrays.

7. The method of claim 1, wherein said generating the plurality of bank histograms comprises combining key counts from local histograms corresponding to a same bucket across all subarrays in a memory bank.

8. The method of claim 1, further comprising determining a radix for sorting the dataset based on key size and distribution, wherein the radix includes at least one of a binary radix or a decimal radix.

9. The method of claim 1, wherein said generating a plurality of local histogram comprises iteratively generating local histograms until covering a full radix range.

10. The method of claim 1, wherein the 3D-stacked memory of the PIM-based system comprises multiple layers, the multiple layers including the plurality of subarrays, each layer being interconnected through vertical interconnects to enable efficient communication between the layers.

11. The method of claim 10, wherein the vertical interconnects include through-silicon vias (TSVs) to facilitate high-speed data transmission and reduce latency.

12. The method of claim 1, wherein the 3D-stacked memory of the PIM-based system utilizes a Dragon topography with 8 memory layers, and each memory layer comprises 64 memory banks.

13. The method of claim 1, wherein said performing the prefix-sum operation on the plurality of bank histograms comprises using parallel prefix-sum techniques.

14. A computer-readable medium storing instructions, that when executed by a processing in memory (PIM) based system, cause the system to perform a method for sorting a dataset, the method comprising:
receiving a request to sort a dataset stored in a 3D-stacked memory of the PIM-based system, wherein the request identifies a specific dataset and sorting criteria, wherein the sorting criteria includes a plurality of keys used to sort pieces of data in the dataset;
partitioning the dataset into a plurality of subarrays across a plurality of memory banks within the 3D-stacked memory, wherein each subarray includes at least one piece of data from the dataset;
separating each piece of data in each subarray into a plurality of buckets based on the plurality of keys, wherein each bucket corresponds to a particular key of the plurality of keys, wherein a same plurality of buckets is used for each subarray;
generating a plurality of local histogram for each subarray, wherein each local histogram of a particular subarray corresponds to a particular bucket of the plurality of buckets, and wherein each local histogram indicates a frequency of a particular key in the corresponding bucket;
generating a plurality of bank histograms based on the plurality of local histograms, wherein each bank histogram corresponds to a particular bucket of the plurality of buckets, wherein the generating comprises combining key counts from all local histograms corresponding to a same bucket of the plurality of buckets;
performing a prefix-sum operation on the plurality of bank histograms to determine individual positions of the pieces of data for a sorted dataset;
aggregating the subarrays from all memory banks to form the sorted dataset based on the individual positions; and
returning the sorted dataset.

15. The computer-readable medium of claim 14, wherein said partitioning the dataset comprises partitioning the dataset in a manner that substantially evenly distributes the data across the memory banks.

16. The computer-readable medium of claim 14, wherein separating each piece of data in each subarray into a plurality of buckets based on the plurality of keys comprises performing local binary radix sorting within each subarray to sort the pieces of data according to their corresponding keys.

17. The computer-readable medium of claim 14, wherein the local binary radix sorting within each subarray is performed concurrently across all subarrays, thereby concurrently sorting the pieces of data based on their corresponding keys.

18. The computer-readable medium of claim 14, wherein said separating is based on a radix sort technique.

19. The computer-readable medium of claim 14, wherein the method further comprises determining a radix for sorting the dataset based on key size and distribution, wherein the radix includes at least one of a binary radix or a decimal radix.

20. A processing in memory (PIM) based system for sorting a dataset, the system comprising:
a 3D-stacked memory configured to store a dataset, the 3D-stacked memory including a plurality of memory banks and partitionable into a plurality of subarrays across the memory banks, wherein each subarray includes at least one piece of data from the dataset;
a processing unit configured to receive a request to sort the dataset, the request identifying a specific dataset and sorting criteria, wherein the sorting criteria includes a plurality of keys used to sort pieces of data in the dataset;
a plurality of subarray-level processing units (SPUs) operatively coupled to the subarrays, the SPUs configured to separate each piece of data in each subarray into a plurality of buckets based on the plurality of keys, wherein each bucket corresponds to a particular key of the plurality of keys, and to generate a plurality of local histograms for each subarray, wherein each local histogram of a particular subarray corresponds to a particular bucket of the plurality of buckets and indicates a frequency of a particular key in the corresponding bucket;
a bank histogram generator configured to generate a plurality of bank histograms based on the plurality of local histograms, wherein each bank histogram corresponds to a particular bucket of the plurality of buckets, and wherein the generating comprises combining key counts from all local histograms corresponding to a same bucket of the plurality of buckets;
a prefix-sum operation module configured to perform a prefix-sum operation on the plurality of bank histograms to determine individual positions of the pieces of data for a sorted dataset; and
an aggregator configured to aggregate the subarrays from all memory banks to form the sorted dataset based on the individual positions and to return the sorted dataset.
